(19) United States
(12) Patent Application Publication
(10) Pub. No.: US 2010/0184008 A1
(43) Pub. Date: Jul. 22, 2010

(54) 3D EFFECT TOPOGRAPHICAL MAPS AND METHOD OF MAKING SAID MAPS

(76) Inventors: Derek Fergus, Salem, OR (US); Will Macia, Camas, OR (US); Wade Fergus, Silverton, OR (US)

Correspondence Address: Bruce E. Harang, PO BOX 872735, VANCOUVER, WA, 98687-2735, US

(21) Appl. No.: 12/355,711

(22) Filed: Jan. 16, 2009

(51) Int. Cl. G09B 29/00

(52) U.S. Cl. 434/150

(57) ABSTRACT

A weatherproof topographical map having a 3D image effect printed on a weatherproof flexible fabric allowing the production of a map which is easy to use and store without the tendency to lose detail along fold lines. And a method of making a weatherproof topographical map having a 3D image effect particularly suitable for use by outdoor users having weatherproof/waterproof features as well as 3D rendering of elevations and easy to find and read information.

### BACKGROUND OF THE INVENTION

1. Field of the Invention

The present invention generally relates to 3D effect weatherproof topographical maps and particularly to 3D effect weatherproof topographical maps on flexible fabric and a method of making said 3D effect topographical flexible fabric maps.

2. Description of the Related Art

Maps include geographic drawings showing details countries, cities, rivers, bodies of water, mountains, and other features of interest. Maps more suitable for outdoor use include the federally published topographical maps known as USGS quadrant maps for example. These maps highlight features more important to outdoor users such as elevation changes, rivers, trials, paths, and the like. However, using these paper substrate maps in the field can be difficult especially under adverse weather conditions. Further not all of the information important and desirable for the outdoor users is included.

The use of computers and computerized data and printers is known in the production of maps. For example, U.S. Pat. No. 7,425,968 issued Sep. 16, 2008 to Gelber discloses a method for labeling maps using a computer program employing cartographic heuristics ranking the priority of labels and preventing label overlap and U.S. Pat. No. 6,812,925 issued Nov. 2, 2004 5 to Krishnan et al. discloses a computerized system of performing dynamic view dependent simplification of large geographic area maps.

However there remains a need for maps used by hunters, wilderness rescue personnel, fishermen, and other outdoor activity participants show details like counties, springs, hiking trails, logging roads and many other features important to outdoor users. Particularly useful are such maps printed with 3D effect topography and most particularly weatherproof maps printed with 3D effect topography on flexible fabric. Further, there remains a need for maps that once folded do not lose both detail and physical substrate integrity along said fold lines.

It would, therefore, be desirable to provide a map that overcomes the aforesaid and other disadvantages.

### DISCLOSURE OF THE INVENTION

The present invention provides advantages and alternatives over the prior art by providing a topographical maps that are durable, and not effected by weather conditions in the outdoors while also providing easy to read features.

A further aspect of the present invention provides a weatherproof topographical map having a 3D image effect comprising: a weatherproof fabric substrate and; a topographical map having a 3D image effect using weatherproof inks printed thereon.

According to another aspect of the present invention is a weatherproof topographical map having a 3D image effect on a flexible fabric substrate which eliminates degradation of detail and substrate along fold lines.

According to yet another aspect of the present invention there is provided a method for making a weatherproof topographical map having a 3D image effect on a flexible fabric substrate comprising: a) retrieving the desired latitude & longitude graticule data; b) retrieving the desired digital elevation model imagery data corresponding to said desired latitude & longitude graticule of step a); c) retrieving the desired geographic place names data corresponding to said desired latitude & longitude graticule of step a); d) retrieving the US forest service roads, trails, and barriers data corresponding to said desired latitude & longitude graticule of step a); e) retrieving the federal and state highways data corresponding to said desired latitude & longitude graticule of step a); f) retrieving other local roads data corresponding to said desired latitude & longitude graticule of step a); g) retrieving game management units data corresponding to said desired latitude & longitude graticule of step a); h) retrieving water courses, water bodies and water springs data corresponding to said desired latitude & longitude graticule of step a); i) retrieving wilderness areas data corresponding to said desired latitude & longitude graticule of step a); j) retrieving geographic names information corresponding to said desired latitude & longitude graticule of step a); k) spatially referencing the retrieved data of steps a) through j) to a single common projection of Universal Transverse Mercator; l) creating a hill shade model of the digital elevation model imagery data of step b) and incorporating said hill shade model into said topographical map thereby providing a 3D image effect; m) establishing property ownership by assigning a desired color and color transparency to each type of property; n) changing all symbols and text included in the data of steps a) through j) to white; o) assigning each type of symbol colored white in step m) to a desired uniform line color and halo color for each of like symbols; p) exporting the resulting data file created by steps a) through 0) as an encapsulated postscript file; q) printing said encapsulated postscript file of step p) onto a desired substrate; thereby producing a topographical flexible fabric substrate map having a 3D image effect showing locations of desired geographical features.

According to a yet further aspect of the present invention there is provided a computer file capable of being set to a printer capable of producing a weatherproof topographical 3D image effect map on a flexible fabric substrate.

According to still another aspect of the present invention there is provided a weatherproof topographical 3D image effect map printed on a woven synthetic fabric substrate.

The present invention thus advantageously provides a weatherproof topographical map having a 3D image effect, having information displayed desirable to outdoor users such as hunters and wilderness rescue crews, and further being waterproof and preferably printed on a flexible woven fabric that allows easy storage and durability in the field under all weather conditions.

### BRIEF DESCRIPTION OF THE DRAWINGS

FIG. 1 shows a weatherproof color 3D effect topographical map of the present invention.

FIG. 2 shows a diagram of computer hardware architecture compatible with the present invention.

FIG. 3 shows a flow chart of the overall schema of the present process.

FIG. 4 shows a flow chart of the schema for spatially referencing the retrieved data to a single common projection of Universal Transverse Mercator.

FIG. 5 shows a flow chart of the schema for creating a hill shade model of the digital elevation model imagery data of step b) and incorporating said hill shade model into said topographical map thereby providing a 3D image effect.

### DESCRIPTION OF THE PREFERRED EMBODIMENTS OF THE INVENTION

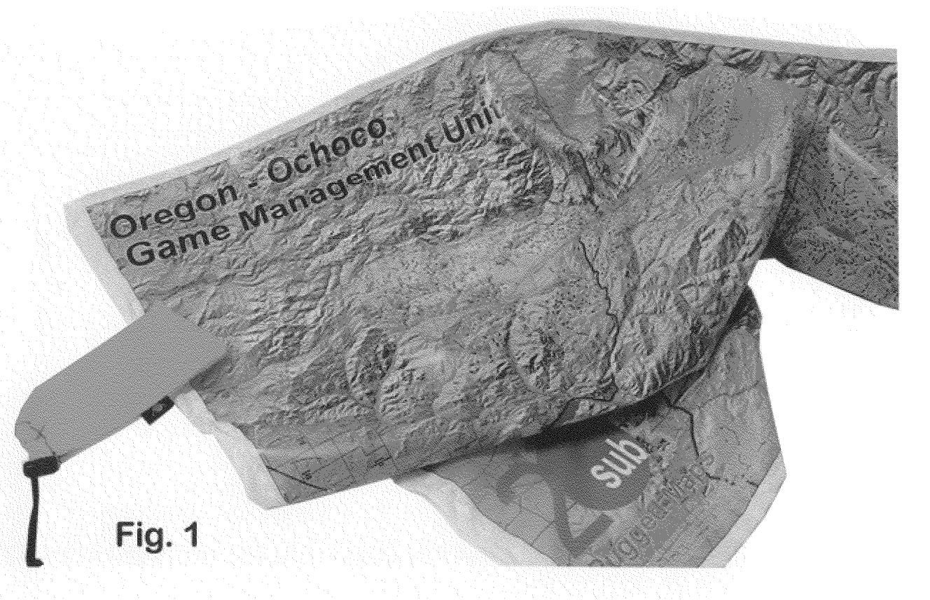

Reference will now be made to the drawings, wherein to the extent possible like reference numerals are utilized to designate like components throughout the various views. Referring to FIG. 1, there is presented a weatherproof topographical map having a 3D image effect comprising a weatherproof fabric substrate and a topographical map having a 3D image effect using weatherproof inks printed thereon of the claimed invention. The 3D effect is created by using a hill shade overlay produced in step l of the presently claimed method. Color and partial transparency are used to allow for rapid location of the various land ownership units. These include, for example, Bureau of Land Management (BLM) lands, Bureau of Indian Affairs lands, state game lands, and the like. Geographical items are presented using shape and color to allow for easy location. These include, for example, federal and state highways, local roads, U.S. Forest Service roads and barriers, tracks, trails, water springs, water courses such as rivers and streams, lakes, reservoirs, and the like. Textual labels are enhanced for easier location and greater legibility by the use of text color and text halo of a contrasting color. Preferably this halo color is white. It is to be appreciated that depending on the proposed use of the map created by the present process different and/or additional feature data may be utilized. Thus, the use of more water course data for a fishing map or more terrain elevation and water spring location for a hunting map is contemplated by Applicants.

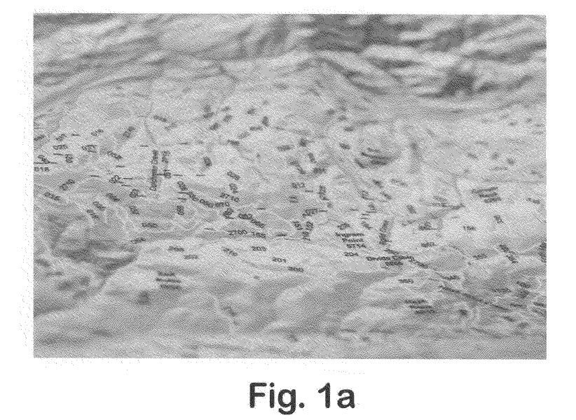

Referring now to FIG. 2, there is presented a schema or diagram of computer hardware architecture compatible with the present method including a digital processing apparatus. This hardware is a general-purpose or a personal computer 100 which may include in a suitable enclosure 1 a central processor, system memory, disk storage (e.g., hard drive, floppy drive, CD-ROM drive, or DVD drive), controller, network adapter, video adapter, and monitor 2. Data input may be through one or more of the following agencies: keyboard 3, pointing device 4, network server 5, backup network server 6 firewall 7, network router 8 local area network 10, modem 9 and wide area network (e.g., internet) conductivity. While a generally suitable computer hardware architecture has been illustrated it is to be appreciated that one or more features of the computer as illustrated may be omitted while still permitting the practice of the present invention. It is to be further understood that more than one computer may be utilized to do different portions of the claimed method. Thus a first computer may be utilized to create the map file and a second computer may be utilized to print the map from the map file created on the first computer.

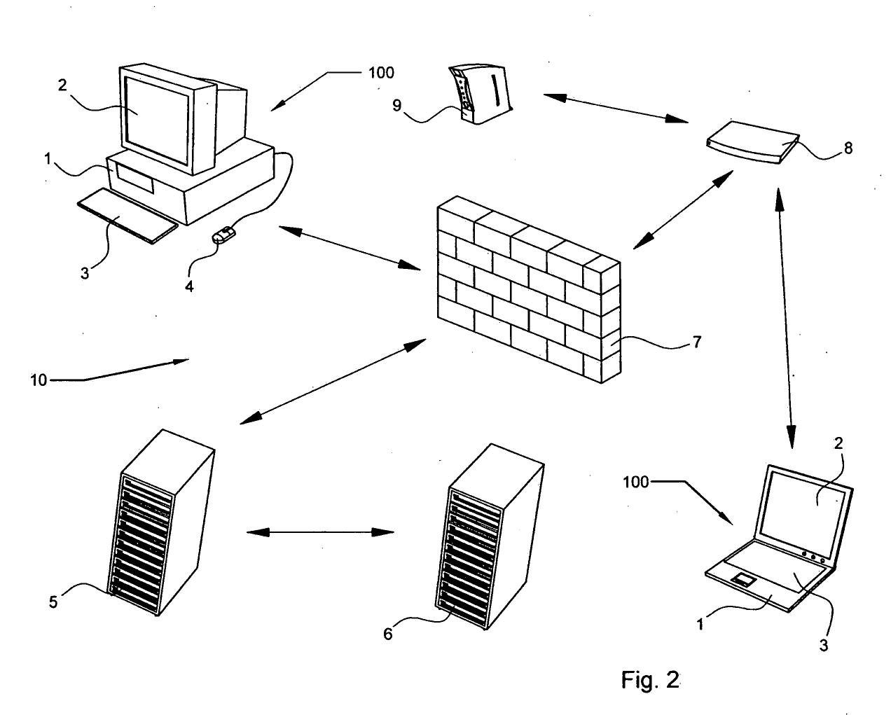

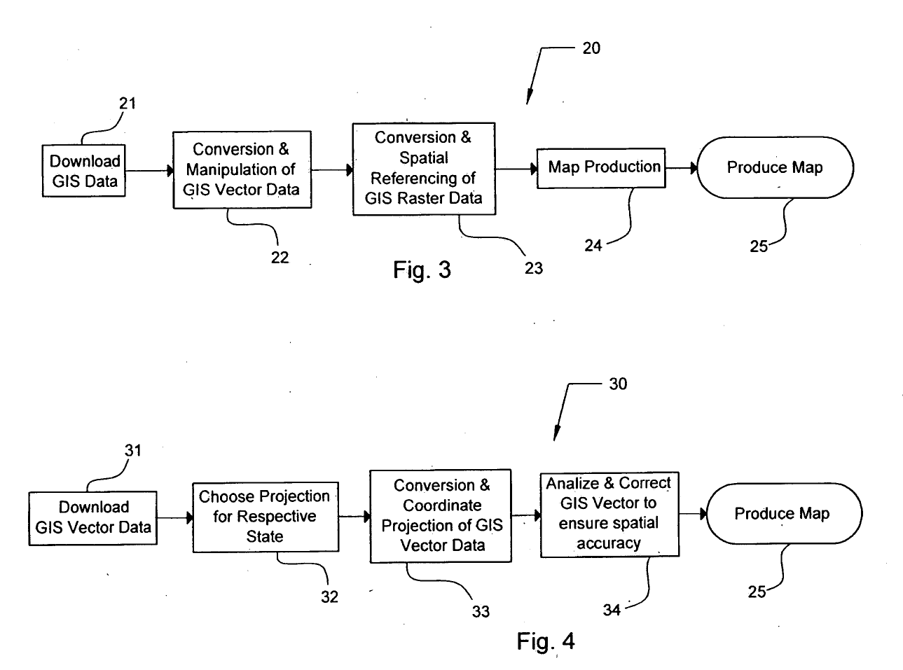

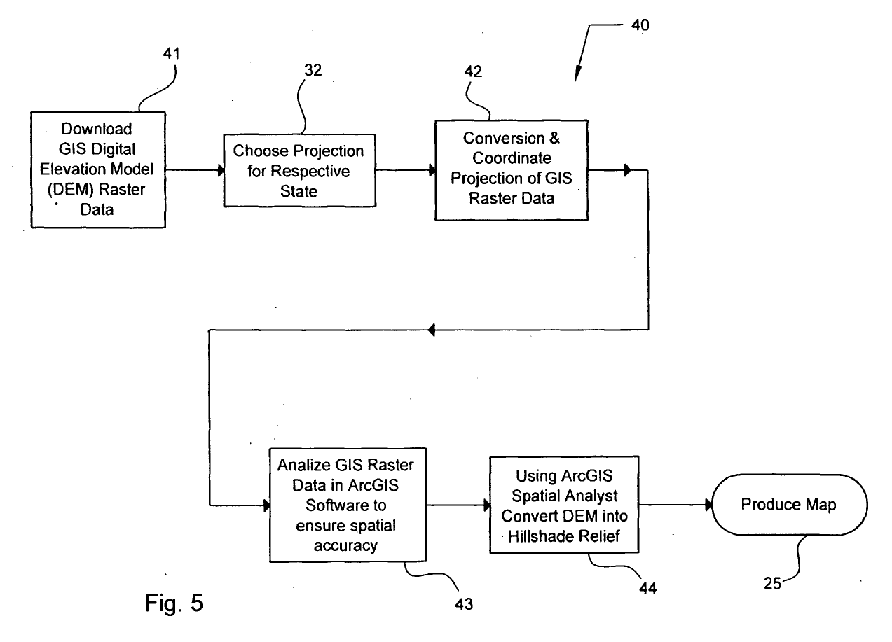

Referring to FIG. 3, there is presented a schema or diagram of a preferred embodiment the method of the present invention for the production of a topographical map having a 3D image effect. The method 20 is initiated by the use of computer hardware of the type diagramed in FIG. 2 to retrieve the desired data in electronic form from remote data banks via the internet. For producing maps of the present invention particularly suitable for outdoor users this desired data includes, for example, Latitude & longitude graticule; elevation model imagery; geographic place names; U.S. Forest Service roads, trails, and barriers; federal and state highways; other local roads; game management units; water courses, water bodies, and water springs; and wilderness areas. Other data suitable for use with the present invention include, for example, Bureau of Indian Affairs areas, national parks, state parks, and the like. Collectively this collection of data will alternatively be herein referred to as GIS data 21. In practice the latitude & longitude graticule files; federal and state highways files; other local roads files; game management unit files; water courses, water bodies, and water springs; and wilderness areas are downloaded via the internet from the appropriate state agency and stored as an electronic file. The digital elevation model files and the geographic place name files are likewise downloaded over the internet from the U.S. Dept. of Agriculture and stored as electronic files. The U.S. Forest Service roads, trails, and barriers files are downloaded from the Forest Service website via the internet and stored as an electronic file. These files will be combined as a series of layers to form the final map. In order to do this the files must first all be spatially referenced such that they all have common spatial coordinate system based on the Universal Transverse Mercator (UTM) so that when the layers are laid over one another they all register or align to a common point 22 and 23. This process is further illustrated in FIG. 4 and discussed hereinbelow. Next the property ownership, such as for example, BLM lands, National Parks, and the like are established by the use of color to differentiate the various owners. Thus, each owner is represented by a unique color. As shown in FIG. 1 for example, BLM lands are Electron Gold color, Forest Service lands are Light Apple color, National Parks are Lilac Dust color, and Bureau of Indian Affairs lands are Yogo Blue color. In addition these ownership colors have a transparency value of about 50% to display the DEM hill shade. Next the roads, fonts, and other geographic and text features of each layer is changed to white in color so a uniform color for each feature may be added to the final map. For water bodies, water courses, and water springs this assigned common color in FIG. 5 is Cretean Blue. Similarly, fonts are all changed to a common text font and a common color of white. The Wilderness areas and Game Management areas each have a unique color and a transparency in the range of about 40% to about 60% to display the DEM hill shade. Finally, a legend, north arrow, scale bar, map title, disclaimer and source trademark are added to the electronic map file as another layer. Finally, the multi-layer file is exported as a single layer image file, preferably in an encapsulated postscript (.eps) format for printing 24.

The single layer image file created above may be printed on any suitable printer and on any suitable substrate using known software 25. Suitable printers are manufactured by Roland, Gerber, Epson, and Mimaki. The presently preferred printers are the JV-3 and JV-33 models manufactured by Mimaki. Preferably the suitable substrate is a weatherproof/waterproof substrate, most preferably a weatherproof/waterproof fabric. Suitable inks are manufactured by Gerber and LysonR for example, presently preferred are the BigSol Hi-Load solvent inks of LysonR. Suitable substrates are manufactured by DuPont Corp., Glen Raven Mills, 3M Corp., and NuSign. The presently preferred fabric is woven polyester having a matte finish and is woven of about 150 denier yarn. One such suitable woven polyester fabric is sold under the trade name NuFlex Polysilk from NuSign Supply, Inc., City of Industry, CA 91745. The presently preferred NuFlex Polysilk polyester fabric contains a 150/150 denier yarn with a weave density of 18/12 thread count per inch and a matte finish.

Referring now to FIG. 4 there is shown a schema or diagram of the sub-method or sub-routine utilized to spatially referencing all of the retrieved data to a single common projection of Universal Transverse Mercator 30. The GIS vector data is downloaded 31 and then the desired projection for the selected map area is selected 32, next the GIS data is converted and coordinated as needed 32, then the data is analyzed and corrected to ensure spatial accuracy, finally the resulting map file is sent to a map printer 25.

Turning now to FIG. 5 there is shown a schema or diagram of the sub-method or sub-routine 40 for creating a hill shade model of the digital elevation model imagery data and incorporating said hill shade model into said topographical map thereby providing a 3D image effect. In practice the raw digital elevation model (DEM) 41 is retrieved via the internet from the USDA. These raw digital elevation model files are provided on a county-by-county basis per state and are then merged together into a single digital elevation model (DEM) file by spatial analysis software. The single DEM is then converted to a hill shade model and incorporated into the desired map as an overlay to create the 3D effect of the terrain elevation changes. This sub-routine 40 comprises downloading the digital elevation model (DEM) 41, selecting the desired projection for the selected state 32, the conversion and coordinate projection of GIS raster data 42, GIS raster data analyzed to ensure spatial accuracy 43, converting the DEM into a hillside relief 44 to produce a 3D effect on the map, and production of the map 25

One particularly preferred embodiment of the present invention provides for a weatherproof topographical map having a 3D image effect comprising: a weatherproof fabric substrate; and a topographical map having a 3D image effect using weatherproof inks printed thereon.

Another particularly preferred embodiment of the present invention provides for a topographical map having a 3D image effect on a flexible fabric substrate comprising: a) retrieving the desired latitude & longitude graticule data; b) retrieving the desired digital elevation model imagery data corresponding to said desired latitude & longitude graticule of step a); c) retrieving the desired geographic place names data corresponding to said desired latitude & longitude graticule of step a); d) retrieving the US forest service roads, trails, and barriers data corresponding to said desired latitude & longitude graticule of step a); e) retrieving the federal and state highways data corresponding to said desired latitude & longitude graticule of step a); f) retrieving other local roads data corresponding to said desired latitude & longitude graticule of step a); g) retrieving game management units data corresponding to said desired latitude & longitude graticule of step a); h) retrieving water courses, water bodies and water springs data corresponding to said desired latitude & longitude graticule of step a); i) retrieving wilderness areas data corresponding to said desired latitude & longitude graticule of step a); j) retrieving geographic names information corresponding to said desired latitude & longitude graticule of step a); k) spatially referencing the retrieved data of steps a) through j) to a single common projection of Universal Transverse Mercator; l) creating a hill shade model of the digital elevation model imagery data of step b) and incorporating said hill shade model into said topographical map thereby providing a 3D image effect; m) establishing property ownership by assigning a desired color and color transparency to each type of property; n) changing all symbols and text included in the data of steps a) through j) to white; o) assigning each type of symbol colored white in step m) to a desired uniform line color and halo color for each of like symbols; p) exporting the resulting data file created by steps a) through 0) as an encapsulated postscript file; q) printing said encapsulated postscript file of step p) onto a desired substrate; thereby producing a topographical flexible fabric substrate map having a 3D image effect showing locations of desired geographical features.

Although the preferred embodiments of the present invention has been disclosed, various changes and modifications may be made without departing from the scope of the invention as set forth in the appended claims.

What is claimed is:

1. A weatherproof topographical map having a 3D image effect comprising:
a weatherproof fabric substrate and;
a topographical map having a 3D image effect using weatherproof inks printed thereon.

2. A topographical map having a 3D image effect as claimed in claim 1 wherein, said printing is done using at least about 720 dpi by 720 dpi resolution.

3. A topographical map having a 3D image effect as claimed in claim 1 wherein, said printing is done onto a weatherproof woven fabric substrate utilizing pigment weatherproof inks.

4. A topographical map having a 3D image effect as claimed in claim 1 wherein, said printing is done onto a weatherproof woven fabric substrate utilizing weatherproof dyes.

5. A weatherproof topographical flexible fabric substrate map having a 3D image effect as claimed in claim 1 wherein, said flexible fabric is a woven polyester fabric.

6. A weatherproof topographical flexible fabric substrate map having a 3D image effect as claimed in claim 5 wherein, said woven polyester fabric has a matte finish.

7. A method for making a weatherproof topographical map having a 3D image effect on a flexible fabric substrate comprising:
a) retrieving the desired latitude & longitude graticule data;
b) retrieving the desired digital elevation model imagery data corresponding to said desired latitude & longitude graticule of step a);
c) retrieving the desired geographic place names data corresponding to said desired latitude & longitude graticule of step a);
d) retrieving the US forest service roads, trails, and barriers data corresponding to said desired latitude & longitude graticule of step a);
e) retrieving the federal and state highways data corresponding to said desired latitude & longitude graticule of step a);
f) retrieving other local roads data corresponding to said desired latitude & longitude graticule of step a);
g) retrieving game management units data corresponding to said desired latitude & longitude graticule of step a);
h) retrieving water courses, water bodies and water springs data corresponding to said desired latitude & longitude graticule of step a);
i) retrieving wilderness areas data corresponding to said desired latitude & longitude graticule of step a);
j) spatially referencing the retrieved data of steps a) through i) to a single common projection of Universal Transverse Mercator;
k) creating a hill shade model of the digital elevation model imagery data of step b) and incorporating said hill shade model into said topographical map thereby providing a 3D image effect;
l) establishing property ownership by assigning a desired color and color transparency to each type of property;
m) changing all symbols and text included in the data of steps a) through i) to white;
n) assigning each type of symbol colored white in step m) to a desired uniform line color and halo color for each of like symbols;
o) exporting the resulting data file created by steps a) through n) as an encapsulated postscript file;
p) printing said encapsulated postscript file of step o) onto a desired substrate;
thereby producing a weatherproof topographical flexible fabric substrate map having a 3D image effect showing locations of desired geographical features.

8. The computer file produced by the method as claimed in claim 7.

9. The map produced by the method as claimed in claim 7.

10. A weatherproof topographical flexible fabric substrate map having a 3D image effect as claimed in claim 7 wherein, said flexible fabric is a woven polyester fabric.

11. A weatherproof topographical flexible fabric substrate map having a 3D image effect as claimed in claim 10 wherein, said woven polyester fabric has a matte finish.

12. A weatherproof topographical flexible fabric substrate map having a 3D image effect as claimed in claim 7 wherein, said printing is done using at least about 720 dpi by 720 dpi.

13. A weatherproof topographical map having a 3D image effect as claimed in claim 7 wherein, said printing utilizes waterproof inks.

14. A topographical map having a 3D image effect as claimed in claim 7 wherein, said printing utilizes waterproof pigment containing inks.

15. A topographical map having a 3D image effect as claimed in claim 7 wherein, said printing utilizes waterproof dyes.
